(19) United States
(12) Patent Application Publication
(10) Pub. No.: US 2017/0015899 A1
(43) Pub. Date: Jan. 19, 2017

(54) CONTROLLING SOLID SUSPENSION IN FLUIDS

(71) Applicant: Trican Well Service, Ltd., Calgary (CA)

(72) Inventors: Sarkis R. Kakadjian, The Woodlands, TX (US); Amanda Rodriguez, Humble, TX (US); John Vu, Spring, TX (US); Jose Garza, Kingwood, TX (US)

(73) Assignee: Trican Well Service, Ltd., Calgary (CA)

(21) Appl. No.: 15/279,741

(22) Filed: Sep. 29, 2016

Related U.S. Application Data
(63) Continuation-in-part of application No. 14/644,281, filed on Mar. 11, 2015.

(51) Int. Cl. C09K 8/62; C09K 8/86; E21B 21/00; C09K 8/90; E21B 33/138; C09K 8/035; C09K 8/88

(52) U.S. Cl. CPC C09K 8/62; C09K 8/035; C09K 8/86; C09K 8/882; C09K 8/90; E21B 33/138; E21B 21/003

(57) ABSTRACT

A treatment to temporarily block highly permeable areas in a wellbore having a temperature of less than 160° F. A diverting agent, a catalyzer, and a viscosifier are mixed together and pumped in the wellbore where the treatment flows in the most highly permeable areas. The diverting agent then begins to block those areas as the well is treated finally causing the fluid to divert to other now more highly permeable areas of the wellbore. After less than 48 hours the diverting agent degrades sufficiently to restore the permeablility of the wellbore.

### CROSS-REFERENCE TO RELATED APPLICATIONS

This invention is a continuation in part application and claims priority to U.S. patent application Ser. No. 14/644,281 that was filed on Mar. 11, 2015.

### BACKGROUND

At various times during the life of a well it is desirable to treat the well. Such treatments include drilling, cementing, perforating, fracturing, gravel packing etc. These treatments generally involve pumping fluid with a number of agents typically solids, into the wellbore. For instance when pumping a drilling mud the drilling mud may be a weighted or non-weighted water-based gel. When weighted, the weighting material may be a particulate such as barite.

One of the functions of a drilling fluid is to seal the wellbore so that the fluid is not lost into highly permeable subterranean zones penetrated by the wellbore. This is accomplished by depositing filter cake solids from the drilling fluid over the surfaces of the wellbore then dehydrating the drilling fluid in order to allow the solids to bridge over the formation pores while not permanently plugging the pores.

When drilling a wellbore, the drilling fluid is continuously circulated down the interior of the drill pipe, through the drill bit and back to the surface in the annular area on the outside of the drill pipe. At various points the wellbore may need to be cased. In this event circulation of the drilling fluid ceases while the drill bit and drill pipe are removed from the well and casing is run into the well. With circulation stopped gelled and dehydrated drilling fluid and filter cake is deposited on the walls of the wellbore.

Once the casing has been run into the well typically cement is pumped through the interior of the casing, out the bottom of the casing, and back up the exterior sides of the casing. With cement in the area between the exterior of the casing and the wellbore cement may harden bonding the casing to the wellbore thereby sealing the annular area and preventing fluid communication axially along the exterior of the casing. Unfortunately, the gelled and dehydrated drilling fluid and filter cake tend to provide a barrier between the cement and the desired bonding surface, either the casing or the wellbore, thereby preventing the cement from bonding the casing to the wellbore. Additionally, the drilling fluid is comparatively expensive therefore operators prefer to attempt to retrieve the maximum amount of drilling fluid from the wellbore in an effort to reduce costs. In an attempt to remove the remnants of the drilling fluid from the wellbore prior to cementing a fluid flush a clear fluid pad may be pumped through the wellbore.

Although high fluid permeability is an important characteristic of a hydrocarbon-producing formation, the permeability on the well may be adversely affected by loss of treating fluid into the formation. For example, in a fracturing or fracing treatment it is desirable to control loss of the treating fluid into the formation to maintain a wedging effect and propagate the fracture through the entire formation to improve its permeability. However, there are limitations on the amount of treatment fluid that is able to be pumped downhole at a sufficient pressure. Without a sufficient amount of pressurized fluid the portion of the formation having higher permeability will most likely consume the major portion of the treatment fluid leaving the least permeable portion of the formation virtually untreated. Therefore, it is desired to control the loss of treating fluids to the highly permeable formations during such treatments.

The efficient treatment of the wellbore, at times, requires temporarily reducing permeability of a portion of the formation to increase the availability of treating fluids to the less permeable portion of the formation in order to create a relatively uniform permeability across the formation, the formation zone, or several formations. Several fluid loss agents have been developed for use in these treatments.

Prior fluid loss control agents included dissolvable or degradable materials such as polyglycolic acid and polylactic acid solids. Such materials have been used as diverting agents that are dispersed in the treating fluid to temporarily reduce the permeability of a portion of the formation or a zone of the well. After the treatment is completed the diverting agents then dissolve and flow out of the well once the well is put on production. Unfortunately, these types of diverting agents require relatively high temperatures in order to dissolve. For example, both polyglycolic acid and polylactic acid solids require weeks to reach 80% degradation when the fluid temperature is low temperature or less than 160° F.

Therefore, there is still a need for a low temperature diverting agent which can effectively and temporarily prevent fluid loss including during treatment operations and is capable of being removed from a low temperature well after treatment operations without leaving any residue in the wellbore or in the formation.

### SUMMARY

In an embodiment of the invention isobutylene urea, methylene urea, or formaldehyde urea, well known as agricultural fertilizer, may be used as a diverting agent. Generally, very large amount of the diverting agent is loaded into the fluid system. Usually from between about 20% to about 50% by weight of the fluid system is the diverting agent. A viscosifier is added to carry the diverting agent into the formation. When these materials are used as a diverting agent they are able to flow into the formation zone of high fluid loss and restrict fluid flow through the formation zone. Then at least 80% of the material degrades over the next few days. As the temperature increases the rate of degradation increases and as the temperature decreases the rate of degradation decreases. However, it has been found that in the presence of a small amount of an organic acid catalyzing agent such as citric acid, acetic acid, or formic acid the rate of degradation at low temperatures, temperatures less than 160° F., is vastly increased. Typically, in the presence of an organic acid catalyzing agent, at least 80% of the material degrades within a few hours, typically 3 to 4 hours.

In practice, a well is identified where the temperature of the formation zones are less than 160° F. In such an instance the frac fluid is batch mixed in a slurry form on the surface with at least a viscosity enhancer that can be but is not restricted to guar gum and its derivatives, carboxymethylcellulose, cellulose derivatives, or polyacrylamide derivatives. Immediately prior, usually less than 10 minutes, to pumping the fluid into the wellbore an amount of the diverting material and acid catalyzing agent such as citric acid, acetic acid, or formic acid in either live or encapsulated form is mixed with the fluid. In some instances, such as when a greatly increased rate of degradation is desired, an inorganic acid, such as HCl, may be used as the catalyzing agent. Typically, the small amount of organic acid catalyzing agent is from about 5% to about 50% by weight of the diverting agent. The diverting material in solid form has a size particle distribution between 0.04 mm and 4.00 mm. As fluid is pumped into this formation zone of high permeability the diverting agent begins to seal off the fractures making them less and less permeable eventually causing the fluid to be diverted to a formation zone that was previously less permeable than the initial formation zone. The permeability of the second formation zone is then increased by the fracturing operation while at the same time being filled with diverting agent until the permeability of the second formation zone is reduced by the diverting agent so that the third formation zone is now the highest permeability of the zones to be treated. The fracturing operation is continued so that the third zone is fractured thereby increasing its permeability. After treating all three zones the permeability across each zone is relatively uniform. The process of treating the zones of the well may be repeated until the overall permeability of the desired zones in the well is increased. The diverting agent, in the presence of the catalyzing agent, begins to degrade such that 80% of the material has degraded within a few hours. Typically, the diverting agent that was initially placed will have degraded to the point where it can flow out of the well, once the well is put on production.

### BRIEF DESCRIPTION OF THE DRAWINGS

FIG. 1 is a wellbore having three zones with fractures.

FIG. 2 is a photo of the slotted disk prior to a fluid loss test.

FIG. 3 is a photo of the fluid less cell during a fluid loss test.

FIG. 4 is a photo of the slotted disk saturated with a diverting agent following a fluid loss test.

FIG. 5 is a graph of isobutylene-urea in the presence of various catalyzing agents at 140° F. over time.

FIG. 6 is a graph of isobutylene-urea in the presence of various catalyzing agents at 160° F. over time.

FIG. 7 is a graph of isobutylene-urea in the presence of various catalyzing agents at 180° F. over time.

FIG. 8 is a photo of a 0.1 inch slotted disk that has been removed from a test cell.

### DETAILED DESCRIPTION

The description that follows includes exemplary apparatus, methods, techniques, or instruction sequences that embody techniques of the inventive subject matter. However, it is understood that the described embodiments may be practiced without these specific details.

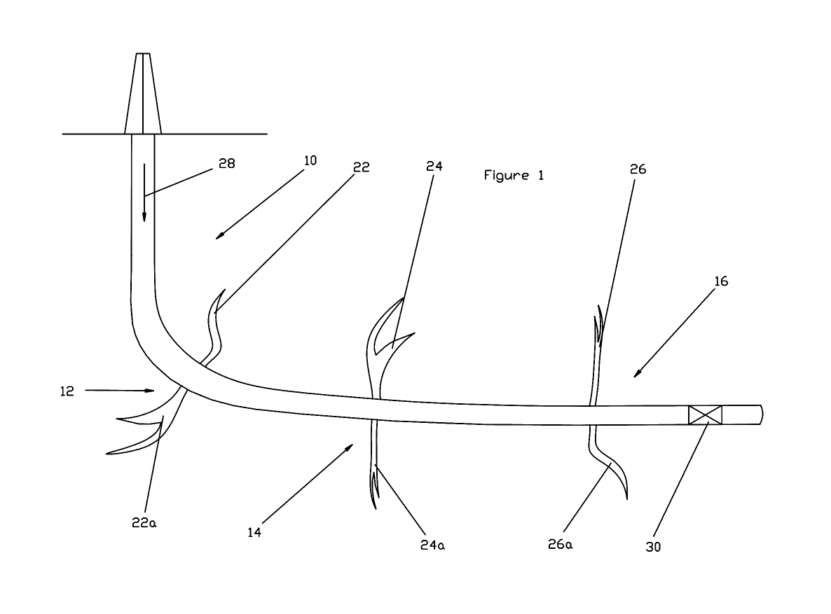

FIG. 1 depicts a wellbore 10 having three formation zones 12, 14, and 16 where fractures 22, 22a, 24, 24a, 26, and 26a have been propagated into each of the three zones 12, 14, and 16. Fracturing fluid is prevented from passing further down the wellbore 10 by bridge plug 30. As diverting fluid, including a diverting agent and catalyzer, is pumped down the wellbore 10 as indicated by arrow 28 the diverting fluid will flow towards the path of least resistance, the most permeable of the three formation zones 12, 14, or 16. If initially formation zone 14 is the most permeable zone the fracturing fluid will initially flow into the formation zone 14 via fractures 24 and 24a. As the fluid continues to be pumped into formation zone 14. The areas of permeability within the formation zone will begin to bridge due to the diverting agent being pumped in to the formation zone 14.

The fluid may be a mixture of viscosified water with guar gum, guar derivatives, carboxymethylcellulose, cellulose derivatives, polyacrylamide polymers, copolymers derivatives or combinations thereof. In certain instances, a friction reducer may be included, preferably carboxymethylcellulose. When low temperature degradation is required, such as when the fluid that is being restricted by the diverting agent is less than 160° F., a catalyzing agent that facilitates the degradation, dissolution, erosion, etc of the diverting agent is added to the fracturing fluid prior to the fracturing fluid being pumped down hole. Preferably the catalyzing agent is added approximately in conjunction with the fracturing fluid entering the wellbore. The catalyzing agent is an organic or inorganic acid but is preferably citric acid or acetic acid added in an amount of between 5% and 50% percent of the total amount of the diverting agent.

From the surface it is very difficult to determine which the amount of fluid that is pumped into a particular formation zone and a predetermined amount of fluid is pumped into the wellbore 10 to fracture the three formation zones 12, 14, and 16. Therefore if all of the fracturing fluid was pumped into formation zone 14 then formation zones 12 and 16 would not be treated or treated to a lesser extent than formation zone 14. However, in this example as more diverting fluid is pumped in the most highly permeable formation zone 14 more diverting agent is also pumped into formation zone 14. As the diverting agent is pumped into formation zone 14 the diverting agent will act to seal the fractures 24 and 24a, including any newly propagated fractures thereby reducing the permeability of the formation zone 14 and causing the fracturing fluid that follows the diverting fluid to flow to next most highly permeable formation zone such as formation zone 16 where the process is repeated until all of the formation zones 12, 14, and 16 have been treated to increase the permeability of all of the formation zones 12, 14, and 16.

Once all of the formation zones 12, 14, and 16 have been treated the formation zones are not initially permeable due to the diverting agent that has been forced into each zone. However, with the presence of the catalyzing agent the diverting agent begins to break down in a few hours. It is generally accepted that upon 80% of the diverting agent degrading, the diverting agent is then able to flow out of the well. Once the diverting has degraded and begins to move out of the fractures and the formation zones the now increased permeability of the formation zones is restored.

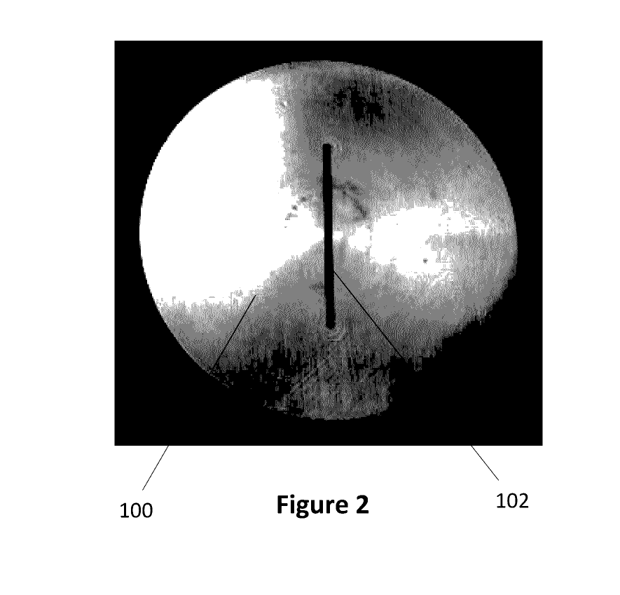

FIGS. 2, 3, and 4 depict a fluid loss control test. FIG. 2 depicts a slotted disk 100 having a 0.1 inch wide slot 102 through the slotted disk 100.

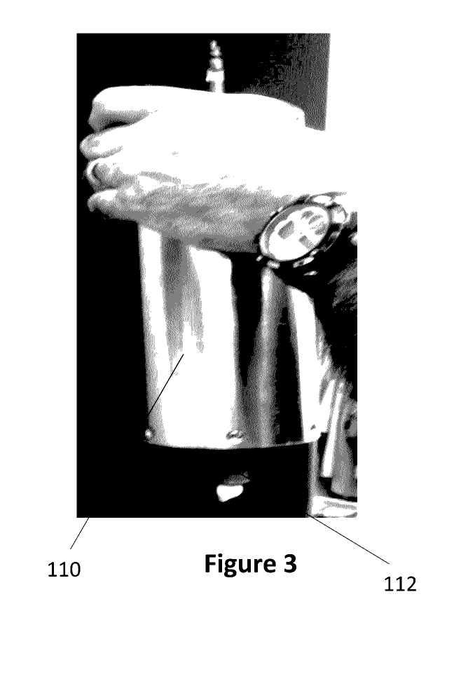

FIG. 3 depicts the fluid loss cell 110. The slotted disk 100 from FIG. 2 is placed in to bottom of the fluid loss cell 110 such that any fluid that exits the fluid loss cell 110 will have to have through the slot 102 and then to exit 112 at the bottom of the fluid loss cell 110. The test is conducted by placing 410 ml of a fracturing fluid into the fluid loss cell. In this test the fluid was mixed in the ratios of 25 pounds of guar viscosifier per 1000 gallons of fluid, 1000 pounds of isobutylene urea per 1000 gallons of fluid, and 1000 pounds of 100 mesh sand per 1000 gallons of fluid. The fluid loss cell was then pressurized to 500 psi. After 30 minutes 55 ml of fluid was lost.

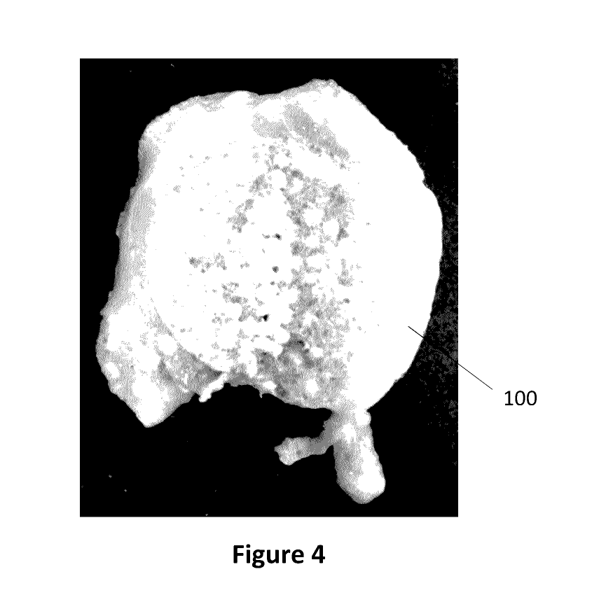

FIG. 4 is the slotted disk 100 after being removed from the fluid loss cell 110. The slot 112 is sealed with diverting agent and sand.

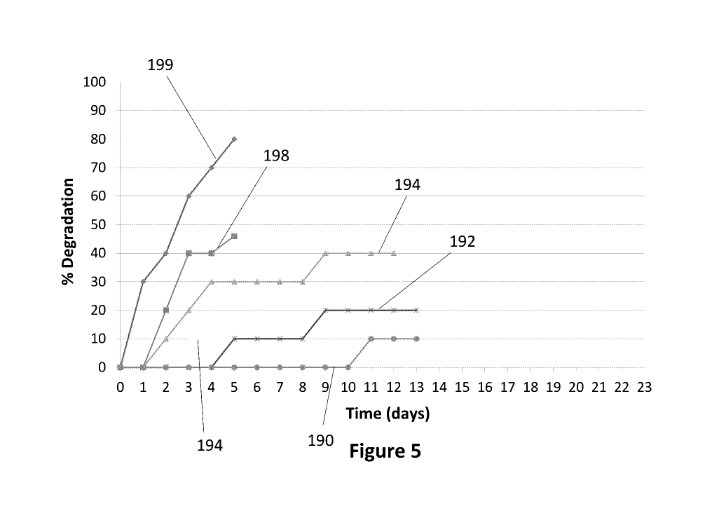

FIG. 5 a graph of the degradation of isobutylene urea in various catalyzing agents at 140° F. over time. Line 190 is the plot of isobutylene urea when using a diverting agent load of 1% citric acid by weight of the total diverting material. The useful degradation amount is generally considered to be about 20% of the diverting agent remains after degradation. In the presence of 1% citric acid the isobutylene urea does not degrade to 20% or less. Line 192 is the plot of isobutylene urea in using a diverting agent load of 3% citric acid by weight of the total diverting material. In the presence of a diverting agent load of 3% citric acid by weight of the total diverting material the isobutylene urea degrades to about 20% remaining in about 9 days. Line 194 is the plot of isobutylene urea in using 5% citric acid. In the presence of a diverting agent load of 5% citric acid by weight of the total diverting material the isobutylene urea degrades to about 20% remaining in about 9 days. Line 196 is the plot of isobutylene urea in using a diverting agent load of 10% citric acid by weight of the total diverting material. In the presence of a diverting agent load of 10% citric acid by weight of the total diverting material the isobutylene urea degrades to about 20% remaining in about 4 days. Line 198 is the plot of isobutylene urea in using a diverting agent load of 15% citric acid by weight of the total diverting material. In the presence of 15% citric acid the isobutylene urea degrades to about 20% remaining in about 3 days. Line 199 is the plot of isobutylene urea in using a diverting agent load of 20% citric acid by weight of the total diverting material. In the presence of a diverting agent load of 20% citric acid by weight of the total diverting material the isobutylene urea degrades to about 20% remaining in about 16 hours.

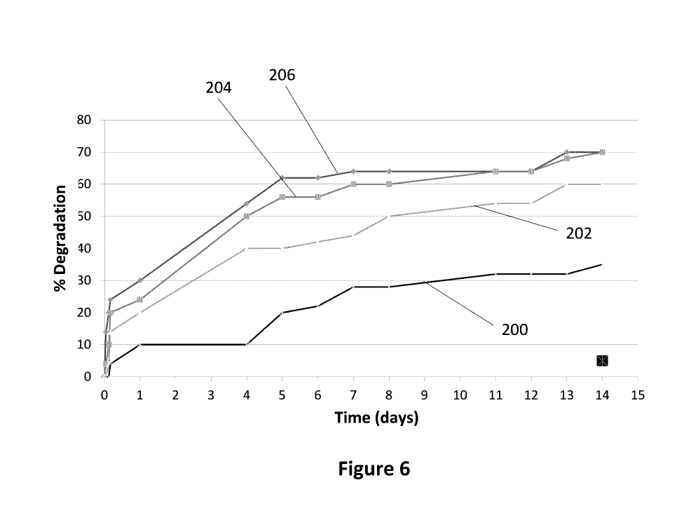

FIG. 6 a graph of the degradation of isobutylene urea in various catalyzing agents at 160° F. over time. Line 200 is the plot of isobutylene urea in using a diverting agent load of 1% citric acid by weight of the total diverting material. In the presence of a diverting agent load of 1% citric acid by weight of the total diverting material the isobutylene urea degrades to about 20% remaining in about 9½ days. Line 202 is the plot of isobutylene urea in using a diverting agent load of 3% citric acid by weight of the total diverting material. In the presence of a diverting agent load of 3% citric acid by weight of the total diverting material the isobutylene urea degrades to about 20% remaining in about 4 days. Line 204 is the plot of isobutylene urea in using a diverting agent load of 5% citric acid by weight of the total diverting material. In the presence of a diverting agent load of 5% citric acid by weight of the total diverting material the isobutylene urea degrades to about 20% remaining in about 4 hours. Line 206 is the plot of isobutylene urea in using a diverting agent load of 5% encapsulated citric acid by weight of the total diverting material. In the presence of a diverting agent load of 5% encapsulated citric acid by weight of the total diverting material the isobutylene urea degrades to about 20% remaining in less than 4 hours.

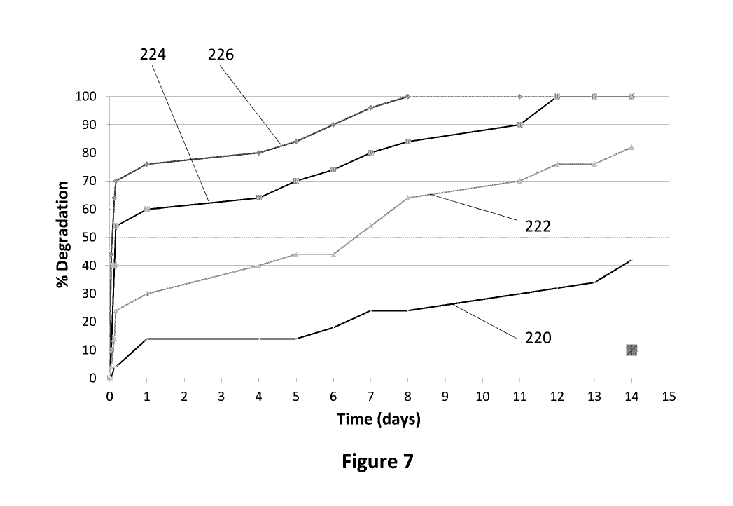

FIG. 7 a graph of the degradation of isobutylene urea in various catalyzing agents at 180° F. over time. Line 220 is the plot of isobutylene urea in using a diverting agent load of 1% citric acid by weight of the total diverting material. In the presence of a diverting agent load of 1% citric acid by weight of the total diverting material the isobutylene urea degrades to about 20% remaining in about 6½ days. Line 222 is the plot of isobutylene urea in using a diverting agent load of 3% citric acid by weight of the total diverting material. In the presence of a diverting agent load of 3% citric acid by weight of the total diverting material the isobutylene urea degrades to about 20% remaining in about 1 day. Line 224 is the plot of isobutylene urea in using a diverting agent load of 5% citric acid by weight of the total diverting material. In the presence of a diverting agent load of 5% citric acid the isobutylene urea degrades to about 20% remaining in less than 4 hours. Line 226 is the plot of isobutylene urea in using a diverting agent load of 5% encapsulated citric acid by weight of the total diverting material. In the presence of a diverting agent load of 5% encapsulated citric acid by weight of the total diverting material the isobutylene urea degrades to about 20% remaining in less than 4 hours.

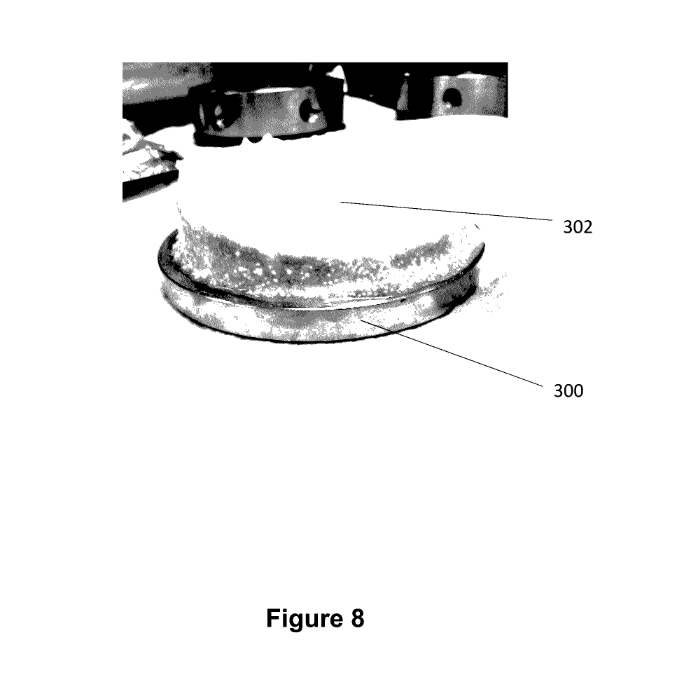

FIG. 8 is a 0.1 inch slotted disk 300 that was removed from a test cell after a fluid loss control test where fluid 302 consists essentially of 1.2 pounds per gallon of isobutylene urea, 0.2 pounds per gallon of a guar viscosifier, and 1 pound per gallon of 100 mesh proppant were mixed and then pressurized through the slotted disk 300. The initial volume in the test cell was 410 ml and the fluid loss after 30 minutes was 72 ml.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A fluid system for treating a well comprising:
a diverting agent, wherein the diverting agent is a solid urea derivative,
further wherein the diverting agent is present in an amount of from about 20 percent by weight of the fluid system to about 50 percent by weight of the fluid system,
a viscosifier, and
a catalyzing agent.

2. The system of claim 1 wherein, the fluid system has a downhole temperature of 160° F. or less.

3. The system of claim 1 wherein, the fluid system has a downhole temperature of 140° F. or less.

4. The system of claim 1 wherein, the viscosifier is a guar gum.

5. The system of claim 1 wherein, the viscosifier is a guar derivative.

6. The system of claim 1 wherein, the viscosifier is a carboxymethylcellulose.

7. The system of claim 1 wherein, the viscosifier is a cellulose derivative.

8. The system of claim 1 wherein, the viscosifier is a polyacrylamide polymer.

9. The system of claim 1 wherein, the viscosifier is a polyacrylamide copolymer.

10. The system of claim 1 wherein, the diverting agent is a solid isobutylene urea.

11. The system of claim 1 wherein, the diverting agent is a solid formaldehyde urea.

12. The system of claim 1 wherein, the catalyzing agent is an organic acid.

13. The system of claim 12 wherein, the organic acid is citric acid.

14. The system of claim 12 wherein, the organic acid is acetic acid.

15. The system of claim 12 wherein, the organic acid is formic acid.

16. The system of claim 12 wherein, the organic acid is between from about 5% to about 50% by weight of the diverting agent.

17. The system of claim 12 wherein, the organic acid is between from about 10% to about 30% by weight of the diverting agent.

18. The system of claim 1 wherein, the catalyzing agent is an inorganic acid.

19. The system of claim 1 wherein, the diverting agent is between 0.5 and 5.0 pounds per gallon of the fluid system.

20. The system of claim 1 wherein the diverting agent in solid form has a size particle distribution between 0.04 mm and 4.00 mm.

21. A method for treating a well comprising:
preparing a fluid system by mixing a viscosifier and a diverting agent,
wherein the diverting agent is present in an amount of from about 20 percent by weight of the fluid system to about 50 percent by weight of the fluid system,
adding a catalyzing agent to the fluid system,
pumping the fluid into a well,
blocking a highly permeable area in a wellbore, and
removing the blockage.

22. The method of claim 21 wherein, the catalyzing agent is added immediately prior to pumping the fluid system into the well.

23. The method of claim 21 wherein, the blockage is removed in less than 24 hours.

24. The method of claim 21 wherein, the blockage is removed in less than 6 hours.

25. The method of claim 21 wherein, the fluid system has a downhole temperature of less than 160° F.

26. The method of claim 21 wherein, the fluid system has a downhole temperature of less than 140° F.

27. The method of claim 21 wherein, the viscosifier is a guar gum.

28. The method of claim 21 wherein, the viscosifier is a guar derivative.

29. The method of claim 21 wherein, the viscosifier is a carboxymethylcellulose.

30. The method of claim 21 wherein, the viscosifier is a cellulose derivative.

31. The method of claim 21 wherein, the viscosifier is a polyacrylamide polymer.

32. The method of claim 21 wherein, the viscosifier is a polyacrylamide copolymer.

33. The method of claim 21 wherein, the diverting agent is solid isobutylene urea.

34. The method of claim 21 wherein, the diverting agent is solid formaldehyde urea.

35. The method of claim 21 wherein, the catalyzing agent is an organic acid.

36. The method of claim 35 wherein, the organic acid is citric acid.

37. The method of claim 35 wherein, the organic acid is acetic acid.

38. The method of claim 35 wherein, the organic acid is formic acid.

39. The method of claim 21 wherein, the organic acid is between from about 5% to about 50% by weight of the diverting agent.

40. The method of claim 21 wherein, the organic acid is between from about 10% to about 30% by weight of the diverting agent.

41. The method of claim 21 wherein, the catalyzing agent is an inorganic acid.

42. The method of claim 21 wherein, the diverting agent is between 0.5 and 5.0 pounds per gallon of the fluid.

43. The method of claim 21 wherein, the diverting agent in solid form has a size particle distribution between 0.04 mm and 4.00 mm.
